(19) United States
(12) Patent Application Publication
(10) Pub. No.: US 2010/0263691 A1
(43) Pub. Date: Oct. 21, 2010

(54) PAINT ROLLER CLEANING SYSTEM AND METHOD

(76) Inventor: ANTHONY R. FRESQUEZ, Rio Rancho, NM (US)

Correspondence Address: LAW OFFICE OF JERRY D. HAYNES , P.A, P.O. Box 350392, Fort Lauderdale, FL, 33335, US

(21) Appl. No.: 12/427,717

(22) Filed: Apr. 21, 2009

(51) Int. Cl. B08B 3/04

(52) U.S. Cl. 134/33; 134/149; 134/115 R

(57) ABSTRACT

The present invention relates to a system and method for cleaning a paint roller. The system according to the present invention includes: a roller holder; an attachment shaft, where the attachment shaft securely attaches to the roller holder; and a means to rotate the attachment shaft and spindle holder assembly at variable speeds. The means to rotate includes a hand held power tool.

### BACKGROUND OF THE INVENTION

1. Field of Invention

The present invention relates to a system and method to clean a paint roller.

2. Description of Related Art

Cleanup after a paint job can be a daunting task. Besides cleaning the general area, i.e., floors, walls or otherwise, the painter needs to clean brushes and rollers that may have been used during the painting. Cleaning brushes may present a challenge; however cleaning of rollers is especially a tough job. Some painters actually decide to discard rollers after use due to difficulty in cleaning.

One method of cleaning rollers involves simply pouring solvent over the roller and then wiping the roller with a towel or a rag in order to absorb the paint. Other methods of cleaning may include detaching the tube from the paint roller and submerging it into water in an effort to soak the paint residue off of the paint roller. Another method of cleaning paint rollers involves detaching the tube from the paint roller, placing it into a housing, then submerging the housing into a solvent which is necessary to remove oil-based paints. After submerging in the solvent, the rollers are rinsed or wiped clean. Consequently the cleaning methods of the prior art may involve a very time consuming process.

The prior art also includes methods that have been developed that involve rotating devices that actually rotate a roller in an effort to discard the remaining paint by using centrifugal force. The rotating method of cleaning a paint roller uses centrifugal force to discard the paint on the roller, however, some of these methods include special devices and tools that aren't always feasible for an average painter. Consequently there remains a need for a system and method to effectively clean a paint roller that reduces some time and effort that's been associated with the methods and systems of the prior art.

### SUMMARY OF THE INVENTION

The present invention relates to a system for cleaning a paint roller comprising: a spindle holder; an attachment shaft, where the attachment shaft is securely welded to the spindle holder; and a means to rotate the attachment shaft and spindle holder assembly at variable speeds. The means to rotate includes a hand held power tool.

The present invention also relates to a method of cleaning a paint roller comprising the steps of: sliding a paint roller on to a spindle holder, where the spindle holder includes an attachment shaft; securing the attachment shaft to a means of rotating the spindle; rotating the spindle at a speed of 60 rpm or less while allowing a stream of warm water to run over the rotating roller; positioning the roller in a vertical position within a receptacle wherein the receptacle includes a plastic and removable lining; rotating the spindle at intervals of spinning bursts up to 1800 rpm; and removing the paint roller from the roller holder to allow the paint roller to dry. The means of rotating includes a power tool, where the intervals of spinning last at least three seconds.

### DESCRIPTION OF DRAWINGS

FIG. 1 depicts a paint roller as used in the prior art.

FIG. 2 depicts a wire spindle according to the present invention.

FIG. 3 shows an assembly of the cleaning system according to the present invention.

FIG. 4 depicts a plastic lined bucket utilized as a part of the cleaning system of the present invention.

### DETAILED DESCRIPTION

The present invention relates to a system and method of cleaning a paint roller that eliminates much of the labor and mess in cleaning paint rollers. The present invention is simple to use, utilizes some tooling available to most painters and creates a system and method to effectively clean a paint roller.

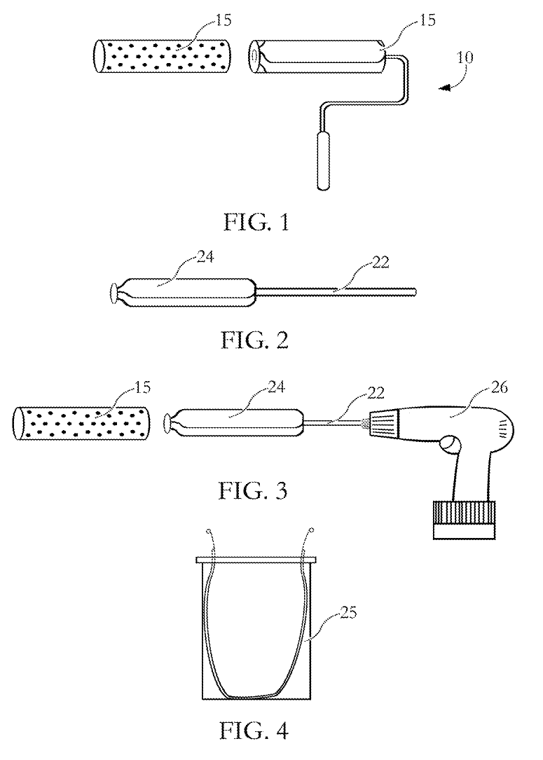

The conventional paint roller tool 10 is depicted in FIG. 1. The paint roller 10 includes a roller 15 that is used for painting purposes. During painting, paint accumulates over the roller and upon completion of the paint job the roller must be cleaned. The present invention provides a spindle holder 24 including a shaft 22. The spindle holder 24 receives the paint roller 15 after it has been removed from the paint roller tool 10. The paint roller 15 is inserted on to the spindle holder 24, which attaches to a drill drive motor 26. In one exemplary embodiment, the shaft 22 may be up to 13 inches in length to provide a means to secure the spindle holder 24 during the cleaning process.

After the roller 15 is inserted upon the spindle holder 24, the shaft 22 that is inserted into the drive motor 26. A depiction of this system is shown in FIG. 3. The driver motor 26 provides the means to rotate the roller at a desired speed during the cleaning process.

The method of cleaning a roller as contemplated by the present invention includes the assembly of the cleaning system as depicted in FIG. 3. After the paint roller 15 is secured onto the spindle holder 24 and attached to the drive motor 26, a user starts the rotation of paint roller at a very slow speed and allows a stream of warm water to transfer over the roller as the drive motor 26 rotates the roller at an effectively slow speed. The slow speed may be as slow as 60 rpm in order to prevent the spraying of paint as the water runs over the paint roller.

The saturation of the roller with water continues for about 10 seconds carefully soaking the entire roller before placing the roller inside a plastic lined 5-gallon-size bucket. After the roller is placed vertically into a receptacle 25, shown in FIG. 4, such as a 5-gallon bucket, the power tool 26 is adjusted to a speed of 1800 RPM for about 3 seconds. This burst of spinning is repeated up to three times or more until the centrifugal force has removed the paint from the paint roller 15. The speed and timing associated with the rotating bursts has been found to be an optimal and effective manner in order to clean a paint roller. At the completion of the removal of the paint, the paint roller 15 is removed from spindle holder 24 and stood on its edge and allowed to dry for about 30 minutes after which the roller may be stored for future use or used again after a rest break.

As stated above in the one particular embodiment, the shaft 22 is 13 inches in length. After the shaft is inserted into the drive motor 26, a significant length of the shaft is coupled to the drive motor allowing 4 inches of the shaft to protrude from the coupling of the drive motor 26. The technique described with the present invention is most effective on a standard 9-inch paint roller although the technique may be used on other sizes of paint rollers with the same degree of effectiveness. Once the rollers are cleaned the bucket liner may be discarded.

Consequently, the present invention provides a convenient and effective method and system to clean paint rollers that reduces the time and the consequential mess associated with cleaning paint rollers. The method also enables the painter to reuse paint rollers, again and again, and avoid purchasing expensive replacements every time. The instant invention has been shown and described in what is considered to be the most practical, economical, efficient, reusable and preferred embodiments by far. It is recognized, however, that departures may be made there from within the scope of the invention and that obvious modifications will occur to a person skilled in the art.

What is claimed is:

1. A system for cleaning a paint roller comprising:
a. a spindle holder;
b. an attachment shaft, where the attachment shaft is securely welded to the spindle holder; and
c. a means to rotate the attachment shaft and spindle holder assembly at variable speeds.

2. The system for cleaning a paint roller according to claim 1, the means to rotate includes a hand held power tool.

3. The system for cleaning a paint roller according to claim 2, where said attachment shaft is 13 inches in length.

4. The system for cleaning a paint roller according to claim 2, where the hand held power tool provides rotational speeds up to 1800 rpm.

5. The system for cleaning a paint roller according to claim 1, further including a cleaning receptacle, where said receptacle includes a plastic and removable lining.

6. A method of cleaning a paint roller comprising the steps of:
a. sliding a paint roller on to a spindle holder, where the spindle holder includes an attachment shaft;
b. securing the attachment shaft to a means of rotating the spindle;
c. rotating the spindle at a speed of 60 rpm or less while allowing a stream of warm water to run over the rotating roller;
d. positioning the roller in a vertical position within a receptacle wherein the receptacle includes a plastic and removable lining;
e. rotating the spindle at intervals of spinning bursts up to 1800 rpm; and
f. removing the paint roller from the roller holder to allow the paint roller to dry.

7. The method of cleaning a paint roller according to claim 7, wherein said means of rotating includes a hand held power drill motor.

8. The method of cleaning a paint roller according to claim 7, where said intervals of spinning last at least three seconds.

9. The method of cleaning a paint roller according to claim 7, further comprising step of, standing the roller in a vertical position to allow the paint roller to dry.
